(19) United States
(12) Patent Application Publication
(10) Pub. No.: US 2005/0114181 A1
(43) Pub. Date: May 26, 2005

(54) Radiology order entry and reporting system

(75) Inventor: Ronald H. Gottlieb, Pittsford, NY (US)

Correspondence Address: BLANK ROME LLP, 600 NEW HAMPSHIRE AVENUE, N.W., WASHINGTON, DC, 20037, US

(73) Assignee: UNIVERSITY OF ROCHESTER

(21) Appl. No.: 10/843,666

(22) Filed: May 12, 2004

Related U.S. Application Data
(60) Provisional application No. 60/469,411, filed on May 12, 2003.

(51) Int. Cl. G06F 17/60

(52) U.S. Cl. 705/2

(57) ABSTRACT

A physician in an emergency room inputs a radiology order into a first mobile device. A radiologist receives the order over a second mobile device and inputs a report into the device. The devices provide prompts to input the information according to American College of Radiology guidelines. Information summaries for billing are produced. Physicians who frequently input inappropriate orders can be identified. A learning system uses patient clinical outcomes and pathology results to assess the usefulness of the examinations being performed.

### REFERENCE TO RELATED APPLICATION

The present application claims the benefit of Provisional Application No. 60/469,411, filed May 12, 2003, whose disclosure is hereby incorporated by reference in its entirety into the present disclosure.

### FIELD OF THE INVENTION

The present invention is directed to an order entry and reporting system and more particularly to such a system which can be easily, but not exclusively, adapted to the needs of radiologists.

### DESCRIPTION OF RELATED ART

Despite tremendous advances in imaging technology, there remains confusion as to which imaging examination to order in specific clinical situations, and results of imaging studies (normal and abnormal) are frequently not conveyed to the appropriate healthcare provider. Inappropriately ordered examinations are extimated to constitute 30% of all radiologic studies (1) and are a large hidden cost in healthcare. When patients undergo the “wrong” study for a particular clinical indication their diagnosis can be delayed and they may undergo additional testing. Additional radiologic imaging increases the cost of care and the possibility of iatrogenic complications from the tests themselves. The reverse situation of not ordering indicated radiologic examinations could also compromise the quality of healthcare. If examinations that should be ordered are not ordered, patient diagnoses could be delayed or missed completely. Evaluation of the clinical effects of not ordering indicated imaging studies is an area which has previously not been studied formally.

Guidelines have been developed by the American College of Radiology (ACR) to aid in selecting the best radiologic imaging studies for specific clinical situations. These guidelines have the potential to reduce the rate of inappropriately ordered examinations and to motivate the ordering of studies which should be performed when indicated. However there has been no system developed to facilitate or monitor compliance with these guidelines. The guidelines have been distributed to radiologists nationwide in hard copy and soft copy versions, but most radiologists do not promote their usage and store them in inaccessible locations for use by referring physicians. This is similar to other siturations in medicine where guidelines have been developed without mechanisms to modify physician behavior to ensure their usage.

Direct verbal consultation between radiologists and referring physicians has also proven unsuccessful in modifying physician radiologic test-ordering practices. Two inpatient studies conducted at university-affiliated medical centers found consultation between the referring physician and radiologist at rounds or by telephone to be an ineffective method of reducing the rate of inappropriate test-ordering. A method that would guide referring physicians when they initially make their radiology examination selections and track their selections over time could potentially be more effective in ensuring appropriate test selection.

Disseminating information to clinicians effectively about appropriate imaging test selection in specific clinical situations may lead to a more streamlined, directed radiologic evaluation of their patients. Providing this information to clinicians in a concise user-friendly format (via an intelligent order-entry system) could facilitate the ordering of appropriate radiologic examinations. Modifying physician ordering practices will require a system that can be easily incorporated in a nonthreatening manner into their clinical practices. A software package providing on-line prompts based on the ACR criteria and other clinically established gudielines would be a quick resource to clinicians ordering imaging studies. On-line clinical guideline prompts have already proven successful in reducing hospital charges. Such a software package could potentially modify physician-ordering practices in keeping with established guidelines.

The same software package could track physicians who repetitively order inapporpriate tests based on established ACR and other criteria. Physicians, using the system, would be provided with a record of their test-ordering practices with the opportunity for change presented to those who consistently order inappropriate studies. This approach has been demonstrated to be successful in reducing the rate of unnecessary surgical procedures. On-going feedback would provide physicians the education and incentive to change based on clearly documented situaations where they are ordering contrary to accepted standards.

An order-entry system, with guideline based prompts is critically dependent on the quality of the information entered. Such a system can be affected by non-compliant physicians entering invalid data to avoid what they perceive as unnecessary “additional” steps in ordering examinations or by nonphysicians entering incorrect information due to the same reason or through lacking adequate knowledge about the clinical status of the patients.

To date there has been no formal assessment of patient throughput based on level of urgency comparing the traditional hardcopy/fax ordering process and an automated order-entry system allowing patient prioritization and scheduling by referring physicians. An automated web based order-entry and scheduling system would allow physicians to choose and schedule the imaging study based on the patient's clinical condition and prioritize them as to when they need to be tested (urgently vs non-urgently).

Mixed results have been reported concerning the effect of improving the patient clinical information provided to radiologists interpreting their imaging studies. Additional clinical information has been found previously not to benefit chest x-ray interpretation. However complex imaging studies such as CT and US have intrinsically more information than plain x-rays. Additional clinical information provided to radiologists through an order entry system may improve interpretations and motivate faster reporting on critically ill patients identified as such by the system.

A system which flags abnormal radiology reports and ensures these reports are communicated to the appropriate healthcare provider would allow for more timely patient care. Currently, the standard is for the radiologist to call abnormal reports but human error can lead to significant findings (e.g., incidental lesions, pneumonias, fractures) not being communicated thereby compromising care. In many hospitals, there is no fail-safe mechanism to ensure that abnormal radiology reports rapidly reach the appropriate healthcare provider. An automated system which electronically designates abnormal radiology reports as such and ensures these reports are read by the appropriate healthcare provider will save time (for those attempting to reach the provider) and enhance the fidelity of information flow to improve patient care.

In the emergency department setting, abnormal reports contain acute findings that need to be dealt with rapidly (within 24 hours) and nonacute findings, which may be important but can be dealt with after 24 hours. Delay or inaccurate communication of acute, significant imaging findings can result in serious compromise of patient care.

Nonacute findings, which do not require emergent intervention by ED physicians, are often not reliably communicated to the patient's primary healthcare provider. The failure to communicate this information can result in suboptimal patient care. The frequency of failure to transmit significant non-urgent findings has, to date, not been evaluated.

U.S. Pat. No. 6,029,138 to Khorasani et al teaches a decision support system with particular applicability to radiology. However, it does not overcome all of the above-noted problems.

### SUMMARY OF THE INVENTION

It is therefore an object of the invention to create an easy to use, mobile, order entry and reporting system with highly accurate flow of information between the emergency department physician ordering the imaging study and the radiologist interpreting the examination. We seek to reduce the improper selection of radiologic examinations, facilitate the rapid performance of urgently needed studies, improve the accuracy of information provided to radiologists to improve their interpretations as well as allowing for appropriate billing, and ensure the timely transfer of significant findings on imaging examinations back to emergency department or local community physicians.

It is another object of the invention to realize an order entry system and reporting system which are:
1) mobile in the emergency department setting (e.g., PDA or device functioning as an electronic clipboard) and possibly for radiologists (i.e. using same mobile devices);
2) easy to use (rapid learning curve);
3) fast: The system must provide timely, examination interpretation information back to emergency department physicians including rapid identification and documentation of discrepancies between initial preliminary and final interpretations of imaging studies;
4) informative: This will be accomplished by ensuring emergency department physicians are alerted to significant acute findings and community health care providers are alerted to significant non-acute imaging findings which can affect patient outcomes;
5) accurate: The system must provide radiologists with essential information for examination interpretation, selection, and prioritizing patients. Improvements in examination interpretation, patient throughput based on health states, and reimbursement rates will be measured; and
6) instructive: This will be accomplished by providing emergency department physicians with online feedback as to the appropriateness of imaging studies they are or should be ordering and tracking emergency department physicians who frequently deviate from guidelines (established or developed on an ongoing basis). This information will be provided to the respective emergency department physician in a nonthreatening manner with the goal of improving his/her performance from the resulting educational feedback. The change in performance will subsequently be measured.

To achieve the above and other objects, the present invention is directed to a system in method for performing the following:

Step 1: Extracting Patient Information

Problems:
1. Patient demographics (medical record number, insurance information, age, sex) needs to be entered.
2. Relevant medical information (presenting symptoms, laboratory data, vital signs, physical examination, prior medical history) needs to be entered.
3. Data for 1 and 2 entered at various points into “system” at initial patient encounter. These include: registration into hospital information system by personnel at patient entry into emergency department (triage nurse, secretary); data entered into hardcopy chart by nurse, emergency department physicians; data entered by physicians on requisitions for ordering tests.
4. Data entry frequently repeated by different personnel into different areas (hospital information system, patient chart, requisitions for ordering studies) leading to waste of time and potential for errors.

Solutions:
1. A mobile platform where a variety of people can enter information in sequence, avoiding redundancy and improving accuracy of information exchange. The portable electronic chart could be transferred from triage people and secretaries entering screening data, to physicians and nurses caring for the patient, who in turn can order radiology studies directly from a mobile electronic chart.
2. Software can be developed for all of the interfaces for data entry ensuring it is quick and easy to use to be accepted in a busy emergency department setting.

Step 2: Transfer of Information to Radiology Department to Schedule Examination

Problem:
1. Orders for radiology tests, with accurate patient information (demographics, insurance coverage, reasons for studies), must be sent reliably from electronic charts to radiology.
2. Information must be received and linked with radiology information system to schedule examinations, link reports with patient records, and ensure billing. Accurate information must be provided regarding patient presentations or diagnoses to allow for providing reasons for examinations, which third party payors accept, to reimburse hospital and radiology department. Currently 30-50% of claims are denied by third party payors due to insufficient information provided on claims from billing office.
3. Radiologists, interpreting examinations, must have information available that examinations are completed, and why examinations are performed to know what is to be read and have information to allow them to render best possible readings.

Solutions:
1. Parallel system (PC, windows based, web based or other) in which information entered via electronic mobile patient charts, is downloaded and scheduled into radiology information system (such as IDXrad) by existing schedulers rather than current telephone call or fax based system. Requests lacking necessary information can be flagged with examinations denied (non-urgent studies), tracked (urgent studies). Required information for billing (i.e., insurance carrier) can be filled in at a later date (but during current episode of care).
2. Alternatively, a direct link with the radiology information system can be established from the electronic mobile patient chart via software upgrades.
3. Requisitions for interpreting examinations can be provided to radiologists in usual format to allow them to dictate reports into system in conventional manner. Another option for reporting will be discussed under Step 3.
4. Radiologists will also have electronic clipboard indicating which emergency department patients are having radiology studies, subcategorized into their areas of specialization (e.g., neuro CT, MRI, plain films; Body CT, MRI, plain films, General plain films). This can be done in parallel with the existing system. Patient information will be available as recorded from the emergency department. This method of information exchange would improve on the current system of having a secretary enter patient data into IDXrad to then be transferred to the radiologist via hard copy requisitions. The hard copy requisitions would continue to be available, though during the initial pilot phase.
5. The status of the study as scheduled, completed, and interpreted is currently provided in IDXrad but can be indicated in parallel (assuming no interfaces with IDXrad) by mobile electronic clipboards which communicate via wireless interfaces. The status of the study will be indicated by technologists performing studies and radiologists interpreting studies entering information into the parallel system (established for this project) via mobile electronic clipboards/charts at the times they complete (technologists) or interpret (radiologists) studies. This information is necessary for radiologists interpreting the studies to know when examinations are completed to be read and emergency physicians awaiting patient examination results.

Step 3: Reporting Back to the Emergency Department and Generating Claims

Problems:
1. Preliminary radiology reports are sent back over current PACS (Kodak) and involve an abbreviated initial interpretation of findings by residents and/or attendings. Later permanent reports are generated after being transcribed and are only available hours to days after interpretation. Discrepancies occur between preliminary and final reports leading to inappropriate care, and potential malpractice suits. In addition some reports generated by radiologists (including significant findings) never reach the patient's physician at all.
2. Information for third party payors to allow them to reimburse for examinations is lacking with the current system due to gaps in patient data in following areas: insurance carrier information (carrier I.D. number, social security number), indications for examination recognized by insurance carrier as reimbursable.

Solutions:
1. Radiology reports can be sent via portable electronic charts in structured report format back to referring emergency department physicians who would receive information via their own portable electronic patient records. Permanent reports could be transcribed into IDXrad (radiology information system) at a later date with no discrepancies since final reports would be based on initially generated results. Discrepancies between initial resident reads and final attending interpretations could be documented in the system.
2. Radiology reports would contain information required by billing personnel since this would be entered by the emergency department personnel at the time of the encounter. These reports could be. sent with the bills to insurance carriers reducing the number of bills which are not paid because of missing data.

In at least one embodiment of the invention, the Learning Radiology Order Entry and Reporting System (LROERS) will be designed to “learn” from data entered on patient presentations, the radiology tests selected, the results of these tests, and clinical outcomes, which radiology examinations are useful and which are not helpful in specific patient subgroups. No other system currently has this capability. That system has the following specific aims:
1. Mobile in the ED setting (i.e., personal digital assistant or electronic tablet) resulting in improved efficiency for ED physicians by allowing for ordering examinations at the patient bedside.
2. Easy to use.
3. Instructive by providing ED physicians with online feedback as to the appropriateness of imaging studies they are or should be ordering through prompts developed from existing evidence based guidelines and new guidelines established through tracking radiology examination results, pathology results and discharge diagnoses for specific patient presentations.
4. Maximize claim recoveries from third party payers and minimize fraudulent claims by collecting better patient information to be submitted with the bills to these organizations.

Patient presentations will be captured in the order entry component of LROERS. This data will include age, gender, presenting symptoms, physical examination findings, laboratory results, and relevant past medical history. Physicians will be required to enter a limited differential diagnosis.

Radiology test results will be in a structured format with reports distilled, for purposes of analysis, to positive, negative, or indeterminate in response to the differential diagnosis. Structured reports, with standardized language for the most common emergency department situations, will be created for the prototype. The usefulness of a test will be, in part, determined by the fraction of patients who have positive, negative, or indeterminate radiology test results with respect to the ED physicians' differential diagnosis, other patient presenting data, or both.

Additional data required to comprehensively assess the usefulness of a radiologic examination will be: 1. patient clinical outcomes obtained from ED and hospital discharge International Classification of Disease Codes at the times of the immediate ED visit, and for a defined time period following the initial presentation, and 2. pathology results.

New guidelines can be generated based on LROERS revealing the fraction of patients with specific clinical presentations, undergoing particular radiology examinations, who have positive, negative, or indeterminate test results confirmed by clinical outcomes and/or pathology results. Examples where guidelines can be developed include situations where false positive test results exceed true positive results or where the frequency of positive test results for a given patient presentation is zero or is close to zero.

### BRIEF DESCRIPTION OF THE DRAWINGS

A preferred embodiment of the present invention will be set forth with reference to the drawings, in which:

FIG. 1 is a block diagram showing a system according to the preferred embodiment and the interactions among the various components and users thereof; and

FIG. 2 is a flow chart showing the operation of a reporting system for reporting results of the system of FIG. 1.

### DETAILED DESCRIPTION OF THE PREFERRED EMBODIMENT

A preferred embodiment of the present invention will be set forth in detail with reference to the drawings, in which like reference numerals refer to like elements or steps throughout.

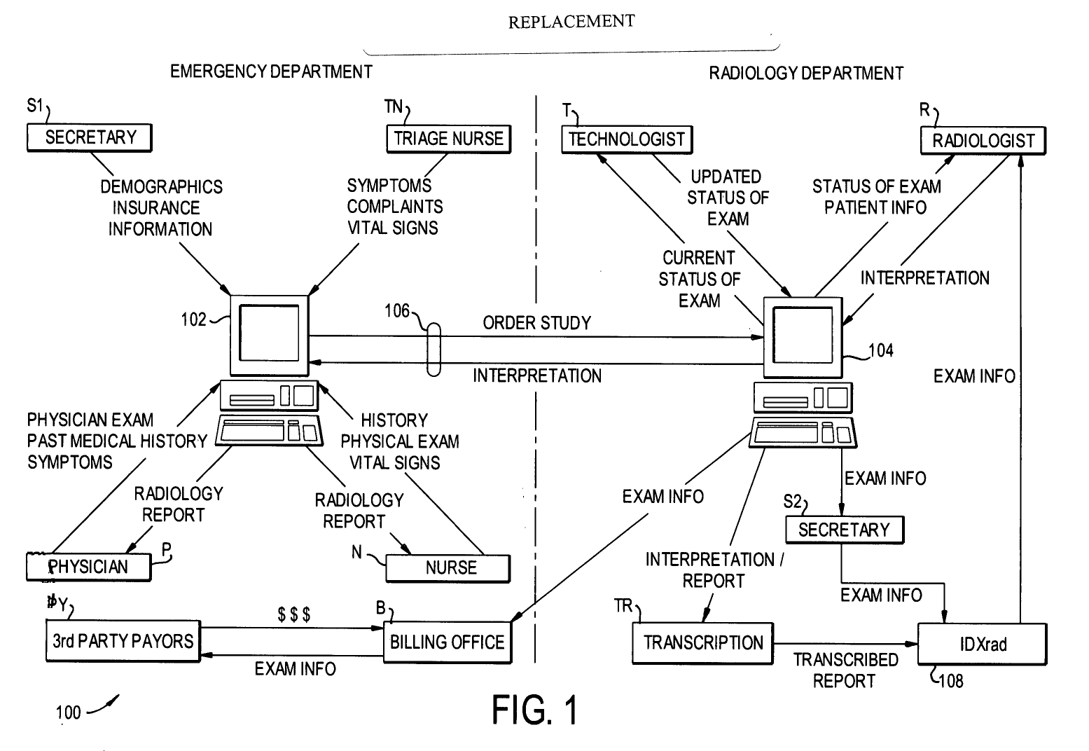

FIG. 1 shows an overview of the preferred embodiment. The system 100 according to the preferred embodiment uses two portable electronic chart/clipboard devices, a first device 102 used in an emergency department of a hospital and a second device 104 used in a radiology department. The devices 102 and 104 communicate over a link 106, which can be a direct wireless link or can include a stationary device or network of stationary devices; the same is true of communication links between the device 102 or 104 and any other device. Hardware on which the devices 102 and 104 can be implemented is known in the art, as are various standards for allowing them to communicate wirelessly, such as variations on IEEE 802.11.

As shown in FIG. 1, various information concerning a patient and a radiology order for the patient is input into the device 102 in the emergency department. A secretary S1 inputs demographic and insurance information concerning the patient. A triage nurse TN inputs information concerning the patient's symptoms, complaints, and vital signs. An emergency-room physician P inputs information concerning that physician's examination of the patient, the patient's medical history, and the patient's symptoms. A nurse N inputs information concerning the patient's history, physical examination, and vital signs. Any of the information inputs just described can be made directly into the device 102 or into a separate computer in communication with the device 102.

An order for a study is transmitted from the device 102 to the device 104 over the communication link 106. In the radiology department, a radiologist R receives the status of the examination and inputs an interpretation of the examination. A technologist T receives the current status of the examination and inputs an updated status of the examination. The interpretation is sent back to the device 102 over the communication link 106. In addition, the interpretation is provided to a transcription office TR for preparation of a transcription, and the examination information is provided to a secretary S2. The transcription office TR and the secretary S2 provide the transcribed report and the examination information, respectively, to a radiology information system 108, which is shown as being implemented with IDXrad, although that example is illustrative rather than limiting. The radiology information system 108 provides examination information to the radiologist R. The device 104 further provides the examination information to a billing office B for billing third-party payors PY.

As explained above, the devices 102 and 104 are programmed to implement a user interface which prompts the users to input information in a structured manner to conform to accepted guidelines. Such an interface can be implemented in any suitable operating system (e.g., any suitable version of Microsoft Windows or Palm OS) or in any suitable device-independent format (e.g., HTML or Java). As also explained above, either of the devices 102, 104, or a remote server in communication with those devices, is programmed to flag abnormal results, so that they can be brought to the attention of the appropriate person expeditiously, and to track orders placed by physicians to determine who frequently deviates from the guidelines.

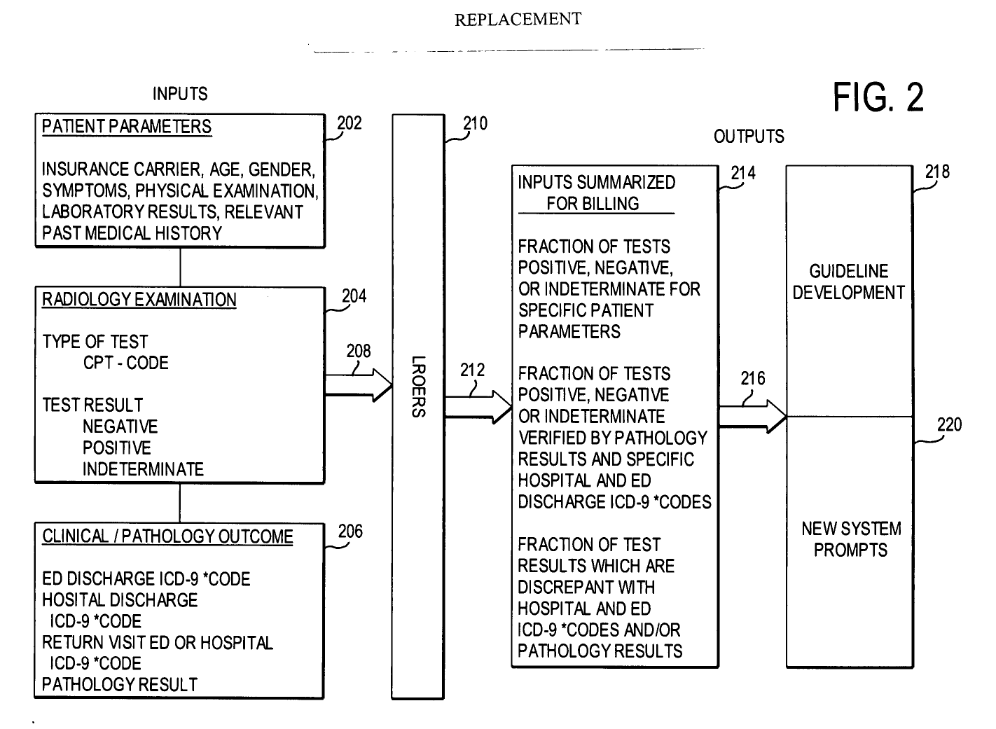

The results of the system 100 of FIG. 1 can be reported, both for billing purposes and to improve the system. A reporting feature will be explained with reference to the flow chart of FIG. 2. As shown in FIG. 2, the inputs for the reporting feature are grouped into three types of inputs 202, 204, and 206. The first group of inputs 202 includes patient parameters, namely, insurance carrier, age, sex, symptoms, physical examination, laboratory results, and relevant medical history. The second group of inputs 204 includes information from the radiology examination, specifically, the type of test and the test result. The third group of inputs 206 includes clinical/pathology outcome information, namely, the emergency department and hospital discharge codes, the return visit emergency department or hospital code, and the pathology result.

The inputs 202, 204 and 206 are input via data entry 208 into the reporting system 210. A primary analysis 212 is performed, resulting in inputs summarized for billing 214. The inputs summarized for billing 214 includes the fraction of tests positive, negative or indeterminate for specific patient parameters, the fraction of tests positive, negative, or indeterminate verified by pathology results and specific hospital and emergency department discharge codes, and the fraction of test results which are discrepant with the discharge codes and/or the pathology results. A secondary analysis 216 can then be performed, which results in information for refining the system, namely, guideline development 218 and new system prompts 220.

While the system was developed for radiology, it has applicability beyond that field. For example, a physician in an emergency department can use the device 102 to order any types of tests or to place any other appropriate order.

While a preferred embodiment of the present invention has been set forth above, those skilled in the art who have reviewed the present disclosure will readily appreciate that other embodiments can be realized within the scope of the present invention. For example, disclosures of specific technologies are illustrative rather than limiting. Also, data entry by a human operator can be replaced by transfer of information over a network, whether wired or wireless. Moreover, any features from the above-cited Khorasani et al patent can be incorporated into the present invention as needed. Therefore, the present invention should be construed as limited only by the appended claims.

1. A method for receiving and processing an order relating to care in an emergency department of a hospital, the method comprising:
(a) providing a first device to a physician in the emergency department, the first device being configured to receive the order and to display a report resulting from the order;
(b) providing a second device to a person or persons who will fulfill the order and provide the result;
(c) providing a communication link between the first device and the second device;
(d) receiving an input of the order from the physician in the first device;
(e) transmitting the order over the communication link from the first device to the second device;
(f) outputting the order on the second device to the person or persons who will fulfill the order;
(g) receiving an input of the report in the second device from the person or persons who fulfill the order;
(h) transmitting the report over the communication link to the first device; and
(i) displaying the report on the first device to the physician in the emergency department.

2. The method of claim 1, wherein the first device is a wireless device, and wherein the communication link comprises a link for communicating wirelessly with the first device.

3. The method of claim 2, wherein the second device is a wireless device, and wherein the communication link comprises a link for communicating wirelessly with the second device.

4. The method of claim 3, wherein the order is a radiology order.

5. The method of claim 4, further comprising transmitting billing information concerning the order from the second device to a billing office.

6. The method of claim 3, wherein step (d) is performed through a first user interface on the first device, and wherein the first user interface provides prompts to the physician to input the order according to a set of predetermined guidelines.

7. The method of claim 6, wherein step (g) is performed through a second user interface on the second device, and wherein the second user interface provides prompts to the person or persons who fulfill the order to input the report according to the set of predetermined guidelines.

8. The method of claim 6, further comprising storing a history of orders and identifying physicians who input orders outside the guidelines.

9. The method of claim 1, wherein step (h) comprises determining whether the report is abnormal and flagging the report if the report is abnormal.

10. The method of claim 1, further comprising storing results for updating of the method.

11. A system for receiving and processing an order relating to care in an emergency department of a hospital, the system comprising:
a first device to a physician in the emergency department, the first device being configured to receive the order and to display a report resulting from the order;
a second device to a person or persons who will fulfill the order and provide the result; and
a communication link between the first device and the second device for transmitting the order from the first device to the second device and transmitting the report over the communication link to the first device.

12. The system of claim 11, wherein the first device is a wireless device, and wherein the communication link comprises a link for communicating wirelessly with the first device.

13. The system of claim 12, wherein the second device is a wireless device, and wherein the communication link comprises a link for communicating wirelessly with the second device.

14. The system of claim 11, wherein billing information concerning the order is transmitted from the second device to a billing office.

15. The system of claim 11, wherein the first user interface provides prompts to the physician to input the order according to a set of predetermined guidelines.

16. The system of claim 15, wherein the second user interface provides prompts to the person or persons who fulfill the order to input the report according to the set of predetermined guidelines.
